(19) United States
(12) Patent Application Publication
(10) Pub. No.: US 2011/0305857 A1
(43) Pub. Date: Dec. 15, 2011

(54) MODIFIED POLYPROPYLENE FOR PACKAGING APPLICATIONS

(75) Inventors: Luyi Sun, Pearland, TX (US); Michael Musgrave, Houston, TX (US); Mahesh Patkar, Houston, TX (US)

(73) Assignee: Fina Technology, Inc., Houston, TX (US)

(21) Appl. No.: 12/814,552

(22) Filed: Jun. 14, 2010

(51) Int. Cl. B32B 1/02; C08L 5/00

(52) U.S. Cl. 428/35.7; 524/27

(57) ABSTRACT

Methods of forming a clear packaging container, polymers for use therein and packaging containers are described herein. The methods generally include providing a propylene based polymer formed from a metallocene catalyst; blending the propylene based polymer with a nonitol-based clarifying agent to form clarified polypropylene; and forming the clarified polypropylene into a packaging container, wherein the packaging container exhibits a gloss that is at least 6% greater than a container formed from a Ziegler-Natta formed propylene based polymer blended with the clarifying agent.

### FIELD

Embodiments of the present invention generally relate to polypropylene compositions. In particular, embodiments of the present invention generally related to modified polypropylene compositions for use in packaging.

### BACKGROUND

An issue of commercial importance in packaging applications is the final appearance of the packaging material, such as gloss. Processes, such as thermoforming, for example, employ heat and/or pressure to convert the polymeric material into the desired end-use article. Unfortunately, a polymer chosen for both its mechanical strength and aesthetically appealing gloss, may suffer a significant reduction in gloss upon processing. Accordingly, it is desired to discover a polymer capable of imparting both mechanical strength in thermoforming and improved optical properties upon thermoforming.

### SUMMARY

Embodiments of the present invention include a method of forming a clear packaging container. The methods generally include providing a propylene based polymer formed from a metallocene catalyst; blending the propylene based polymer with a nonitol-based clarifying agent to form clarified polypropylene; and forming the clarified polypropylene into a packaging container, wherein the packaging container exhibits a gloss that is at least 6% greater than a container formed from a Ziegler-Natta formed propylene based polymer blended with the clarifying agent.

One or more embodiments include the method of the previous paragraph, wherein the clarifying agent includes nonitol, 1,2,3-trideoxy-4,6:5,7-bis-O-[(4-propylphenyl)methylene].

One or more embodiments include the method of any preceding paragraph, wherein the packaging container exhibits a gloss retention of at least about 40% upon thermoforming.

One or more embodiments include the method of any preceding paragraph, wherein the propylene based polymer exhibits a melt flow rate of from about 1 dg/min. to about 100 dg/min.

One or more embodiments include the method of any preceding paragraph, wherein the propylene based polymer exhibits a melting point of from about 130° C. to about 160° C.

One or more embodiments include the method of any preceding paragraph, wherein the clarified polypropylene comprises from about 1500 ppm to about 4500 ppm clarifying agent.

One or more embodiments include the method of any preceding paragraph, wherein the propylene based polymer exhibits an isotacticity of from about 89% to about 99%.

One or more embodiments include the method of any preceding paragraph, wherein the container exhibits a haze that is at least 5% lower than a container formed from a Ziegler-Natta formed propylene based polymer blended with the clarifying agent.

One or more embodiments include the method of any preceding paragraph, wherein the container exhibits a haze that is at least 15% lower than a container formed from an identical propylene based polymer blended with a sorbitol-based clarifying agent.

One or more embodiments include the method of any preceding paragraph, wherein the container exhibits a gloss that is at least 20% higher than a container formed from an identical propylene based polymer blended with a sorbitol-based clarifying agent.

One or more embodiments include a container formed by the method of any preceding paragraph.

One or more embodiments generally include clarified polypropylene. The clarified polypropylene generally includes a propylene based polymer formed from a metallocene catalyst; and a nonitol based clarifying agent, wherein the clarified polypropylene is capable of forming a packaging container exhibiting a haze that is at least 6% lower than a container formed from a Ziegler-Natta formed propylene based polymer blended with the clarifying agent.

### BRIEF DESCRIPTION OF DRAWINGS

FIG. 1 illustrates pictures of packaging materials formed by various clarified polypropylenes.

FIG. 2 illustrates the haze of packaging materials formed by various clarified polypropylenes.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

Embodiments of the invention generally utilize metallocene catalyst to form the polyolefins described herein,

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₅ diolefins, conjugated or nonconjugated dienes, polyenes, vinyl monomers and cyclic olefins, for example. Non-limiting examples of other monomers may include norbomene, norbornadiene, isobutylene, isoprene, vinylbenzocyclobutane, sytrene, alkyl substituted styrene, ethylidene norbomene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example. In particular, embodiments of the invention include blending the polymer with a modifier (i.e., “modification”), which may occur in the polymer recovery system or in another manner known to one skilled in the art. As used herein, the term “modifier” refers to an additive that effectively accelerates phase change from liquid polymer to semi-crystalline polymer (measured by crystallization rates) and may include commercially available nucleators, clarifiers and combinations thereof.

In one or more embodiments, the polymer is blended with a clarifying agent to form a clarified polymer. In one or more specific embodiments, the clarifying agent is a nonital-based clarifying agent. For example, the nonital-based clarifying agent may include nonitol, 1,2,3-trideoxy-4,6:5,7-bis-O-[(4-propylpheny)methylene] (e.g., Millad® NX8000, commercially available from Milliken Chemical).

The modifier is blended with the polymer in a concentration sufficient to accelerate the phase change of the polymer. In one or more embodiments, the modifier may be used in concentrations of from about 5 to about 4500 ppm, or from about 100 ppm to about 4500 ppm or from about 1000 ppm to about 3500 ppm by weight of the polymer, for example.

The modifier may be blended with the polymer in any manner known to one skilled in the art. For example, one or more embodiments of the invention include melt blending the ethylene based polymer with the modifier.

It is contemplated that the modifier may be formed into a “masterbatch” (e.g., combined with a concentration of masterbatch polymer, either the same or different from the polymer described above) prior to blending with the polymer. Alternatively, it is contemplated that the modifier may be blended “neat” (e.g., without combination with another chemical) with the polymer.

### Polymer Product

The polymers (and blends thereof) formed via the processes described herein may include, but are not limited to, polypropylene and polypropylene copolymers, for example. Unless otherwise designated herein, all testing methods are the current methods at the time of filing.

In one or more embodiments, the polymers include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

The propylene based polymers may have a molecular weight distribution (Mₙ/M_{w}) of from about 1.0 to about 20, or from about 1.5 to about 15 or from about 2 to about 12, for example.

The propylene based polymers may have a melting point (Tₘ) (as measured by DSC) of at least about 110° C., or from about 115° C. to about 175° C., or from about 130° C. to about 60° C. or from about 140° C. to about 155° C., for example.

The propylene based polymers may include about 15 wt. % or less, or about 12 wt. % or less 12, or about 10 wt. % or less, or about 6 wt. % or less, or about 5 wt. % or less or about 4 wt. % or less of xylene soluble material (XS), for example (as measured by ASTM D5492-06).

The propylene based polymers may have a melt flow rate (MFR) (as measured by ASTM D-1238) of from about 0.01 dg/min to about 1000 dg/min. or from about 1 dg/min. to about 100 dg/min., for example.

In one or more embodiments, the polymers include polypropylene homopolymers. Unless otherwise specified, the term “polypropylene homopolymer refers to propylene homopolymers or those polymers composed primarily of propylene and amounts of other comonomers, wherein the amount of comonomer is insufficient to change the crystalline nature of the propylene polymer significantly.

In one or more embodiments, the polymers include propylene based random copolymers. Unless otherwise specified, the term “propylene based random copolymer” refers to those copolymers composed primarily of propylene and an amount of at least one comonomer, wherein the polymer includes at least about 0.5 wt. %, or at least about 0.8 wt. %, or at least about 2 wt. %, or from about 0.5 wt. % to about 15.0 wt. %, or from about 1 wt. % to about 10 wt. % comonomer relative to the total weight of polymer, for example. The comonomers may be selected from C₂ to C₁₀ alkenes. For example, the comonomers may be selected from ethylene, propylene, 1-butene, 1-pentene, 1-hexene, 1-heptene, 1-octene, 1-nonene, 1-decene, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

In one or more embodiments, the propylene based polymers include stereospecific polymers. As used herein, the term “stereospecific polymer” refers to a polymer having a defined arrangement of molecules in space, such as isotactic and syndiotactic polypropylene, for example. The term “tacticity” refers to the arrangement of pendant groups in a polymer. For example, a polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain.

In one or more embodiments, the polymers include isotactic polypropylene. As used herein, the term “isotactic polypropylene” refers to polypropylene having a crystallinity measured by ¹³C NMR spectroscopy using meso pentads (e.g., % mmmm) of greater at least about 60%, or at least about 70%, or at least about 80%, or at least about 85% or at least about 90%, for example. In one embodiment, the propylene polymer has a microtacticity of from about 89% to about 99%, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

One or more embodiments include forming a clear packaging container from the polymers described herein. Any method known to one skilled in the art may be utilized to form such container. For example, the polymer may be converted to an intermediate article, referred to as a preform, which may be subsequently converted to an end-use article via a variety of processes, including thermoforming, for example.

As discussed previously herein, thermoforming processes generally result in a loss of gloss from the polymer to the end-use article. However, embodiments of the invention unexpectedly result in articles exhibiting significantly retained gloss. For example, the packaging container may exhibit a gloss retention of at least about 40%, or at least about 50% or at least about 60%. As used herein, the term “gloss retention” refers to articles wherein a significant amount of the gloss exhibited by a preform remains after forming the end-use article. The gloss of the preform and end-use article is determined in accordance with ASTM method D 523. The gloss retention upon conversion of a preform to an end-use article may be calculated according to equation 1:

GR(%)=(Gloss_{end}/Glossₚᵣₑ)×100(1)

where GR is the gloss retention in percent, Gloss_{end} is the gloss of the end-use article and Glossₚᵣₑ is the gloss of the preform.

In addition, the articles formed via the embodiments described herein with the metallocene catalysts exhibit optical properties, such as haze and gloss, which are significantly improved over those articles formed with Ziegler-Natta catalysts. For example, the formed articles exhibit a gloss that is at least 5%, or at least 6% or at least 10% greater than a container formed from a Ziegler-Natta formed propylene based polymer blended with an identical clarifying agent. In addition, the formed articles exhibit a haze that is at least 5%, or at least 7% or at least 10% lower (at 80 mil thickness) than a container formed from a Ziegler-Natta formed propylene based polymer blended with an identical clarifying agent.

The articles further exhibit optical properties that are significantly improved over those articles formed with sorbitol-based clarifying agents. For example, the formed articles exhibit a gloss that is at least about 15%, or at least about 20%, or at least about 25% or at least about 40% greater than a container formed from an identical propylene based polymer blended with a sorbitol-based clarifying agent. In addition, the formed articles exhibit a haze that is at least about 10%, or at least about 15%, or at least about 20% or at least about 30% lower than a container formed from an identical propylene based polymer blended with a sorbitol-based clarifying agent.

### EXAMPLES

Packaging containers were formed with a variety of clarified polypropylene materials and the properties of the resulting containers were analyzed. Polymer “A” refers to a metallocene formed polypropylene random copolymer having a density of 0.900 g/cc, an MFR of 30 dg/min. and a Tₘ of 140° C. Clarifier “1” refers to Millad® 3988, commercially available from Milliken Chemical and Clarifier “2” refers to Millad® NX8000, commercially available from Milliken Chemical. Container “1” was formed with 1900 ppm of Clarifier “1” modified Polymer “A”. Container “2” was formed with 4000 ppm of Clarifier “2” modified Polymer “A”.

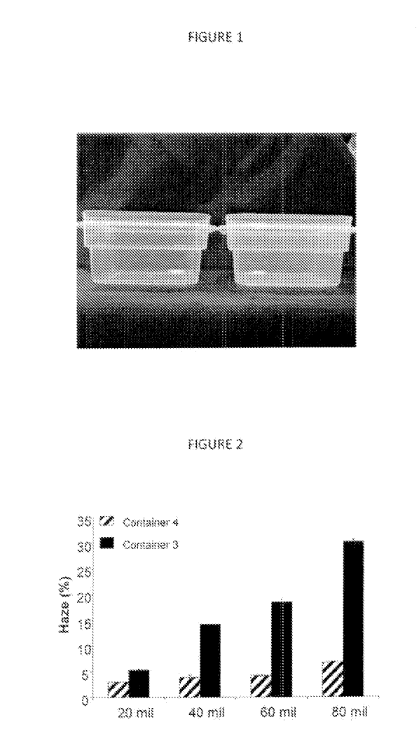

It was observed that Container “2” exhibited significantly lower haze and higher gloss than Container “1”, as illustrated below in Table 1 and shown in FIG. 1.

TABLE 1

| | Container 1 | | Container 2 | |
|---|---|---|---|---|
| | Bottom | Side | Bottom | Side |
| | (2.33 ± 0.20 | (1.58 ± 0.20 | (2.33 ± 0.20 | (1.58 ± 0.20 |
| | mm) | mm) | mm) | mm) |
| Haze (%) | 33.2 | 10.5 | 12.5 | 4.0 |
| Gloss (%) | 65.2 | 75.9 | 83.0 | 87.1 |

Polymer “B” refers to a metallocene formed polypropylene having a density of 0.900 g/cc, an MFR of 12 dg/min. and a Tₘ of 124° C. Container “3” was formed with 1900 ppm of Clarifier “1” modified Polymer B. Container “4” was formed with 4000 ppm of Clarifier “2” modified Polymer “B”.

It was observed that Container “4” further exhibited similar improvements as that of Container “2”, as illustrated in FIG. 2.

Polymer “C” refers to a Ziegler-Natta formed ethylene/propylene random copolymer having a density of 0.9 g/cc, a MFR of 30 dg/min and a Tm of 150° C. Polymer “D” refers to a metallocene formed ethylene/propylene random copolymer having a density of 0.9 g/cc, a MFR of 30 dg/min. and a Tm of 140° C. Container “5” was formed with Polymer “C” and Container “6” was formed with Polymer “D”. Container “5” exhibited a haze (at 60 mils) of 13.9% (in contrast to 10.5% for Container “6”), a haze (at 80 mils) of 25% (in contrast to 19.2% for Container “6”) and a gloss of 70% (in contrast to 76% for Container “6”).

While the foregoing is directed to embodiments of the present invention, other and further embodiments of the invention may be devised without departing from the basic scope thereof and the scope thereof is determined by the claims that follow.

What is claimed is:

1. A method of forming a clear packaging container comprising:
providing a propylene based polymer formed from a metallocene catalyst;
blending the propylene based polymer with a nonitol-based clarifying agent to form clarified polypropylene; and
forming the clarified polypropylene into a packaging container, wherein the packaging container exhibits a gloss that is at least 6% greater than a container formed from a Ziegler-Natta formed propylene based polymer blended with the clarifying agent.

2. The method of claim 1, wherein the clarifying agent comprises nonitol, 1,2,3-trideoxy-4,6:5,7-bis-O-[(4-propylphenyl)methylene].

3. The method of claim 1, wherein the packaging container exhibits a gloss retention of at least about 40% upon thermoforming.

4. The method of claim 1, wherein the propylene based polymer exhibits a melt flow rate of from about 1 dg/min. to about 100 dg/min.

5. The method of claim 1, wherein the propylene based polymer exhibits a melting point of from about 130° C. to about 160° C.

6. The method of claim I, wherein the clarified polypropylene comprises from about 1500 ppm to about 4500 ppm clarifying agent.

7. The method of claim 1, wherein the propylene based polymer exhibits an isotacticity of from about 89% to about 99%.

8. The method of claim 1, wherein the container exhibits a haze that is at least 5% lower than a container formed from a Ziegler-Natta formed propylene based polymer blended with the clarifying agent.

9. The method of claim 1, wherein the container exhibits a haze that is at least 15% lower than a container formed from an identical propylene based polymer blended with a sorbitol-based clarifying agent.

10. The method of claim 1, wherein the container exhibits a gloss that is at least 20% higher than a container formed from an identical propylene based polymer blended with a sorbitol-based clarifying agent.

11. A container formed by the method of claim 1.

12. A clarified polypropylene comprising:
a propylene based polymer formed from a metallocene catalyst; and
a nonitol based clarifying agent, wherein the clarified polypropylene is capable of forming a packaging container exhibiting a haze that is at least 6% lower than a container formed from a Ziegler-Natta formed propylene based polymer blended with the clarifying agent.
